(19) United States
(12) Patent Application Publication
(10) Pub. No.: US 2009/0080123 A1
(43) Pub. Date: Mar. 26, 2009

(54) MAGNETORESISTANCE EFFECT ELEMENT AND MAGNETORESISTIVE DEVICE

(75) Inventors: Yuji Uehara, Kawasaki (JP); Koujiro Komagaki, Kawasaki (JP); Masashi Kawasaki, Miyagi (JP)

Correspondence Address: GREER, BURNS & CRAIN, 300 S WACKER DR, 25TH FLOOR, CHICAGO, IL, 60606, US

(73) Assignees: Masashi Kawasaki, Sendai-shi (JP); FUJITSU LIMITED, Kawasaki-shi (JP)

(21) Appl. No.: 12/181,060

(22) Filed: Jul. 28, 2008

(30) Foreign Application Priority Data
Sep. 21, 2007 (JP) 2007-245933

(51) Int. Cl. G11B 5/127; G11B 5/39

(52) U.S. Cl. 360/324.11; 428/811.2; G9B/5.04

(57) ABSTRACT

The high quality magnetoresistance effect element is capable of reducing resistance in the perpendicular-plane direction and preventing performance deterioration of a barrier layer. The magnetoresistance effect element comprises: a free layer; a pinned magnetic layer; and a barrier layer being provided between the free layer and the pinned magnetic layer, and the barrier layer is composed of a semiconductor.

### BACKGROUND OF THE INVENTION

The present invention relates to a magnetoresistance effect element and a magnetoresistive device, more precisely relates to a magnetoresistance effect element, whose barrier layer is composed of a semiconductor, and a magnetoresistive device using the magnetoresistance effect element.

A tunneling magnetoresistance (TMR) element is an example of magnetoresistance effect elements having barrier layers.

Tunneling magnetoresistance effect was firstly reported in 1975, and a laminated film including a barrier layer composed of alumina (AlO), which has a great MR ratio, e.g., 10% or more, at room temperature, was reported. Since then, research and development of the laminated film have been accelerated to apply the film to next-generation magnetic heads of hard disk drive units, magnetoresistive random access memories (MRAM), etc.

Further, TMR effect films including barrier layers composed of magnesium oxide (MgO), which had significantly great MR ratios, e.g., 100-200%, were reported in 2004 (see Nat. Mater. 3 (2004) 868 by S. Yuasa et al. and Nat. Mater. 3 (2004) 862 by S. S. P. Parkin et al.). The films of this type are now being studied to apply not only MRAM but also magnetic heads of hard disk drive units as promising technology for increasing reproduction output.

As to a magnetic head of a hard disk drive unit, high reproduction sensitivity is required so as to correspond to high recording density. To realize the high reproduction sensitivity, resistance of a magnetoresistance effect element in the perpendicular-plane direction (RA value) must be reduced. For example, the RA value was reduced by reducing a thickness of the barrier layer composed of MgO to about 0.1 nm.

However, by reducing the thickness of the MgO barrier layer, problems of forming pin holes, etc. will occur. As a result, an incidence rate of the problems causing breakdown of the element, e.g., break down voltage reduction, increases.

### SUMMARY OF THE INVENTION

The present invention was conceived to solve the above described problems.

An object of the present invention is to provide a high quality magnetoresistance effect element, which is capable of reducing resistance in the perpendicular-plane direction and preventing performance deterioration of a barrier layer.

Another object is to provide a magnetoresistive device including the high quality magnetoresistance effect element.

To achieve the objects, the present invention has following constitutions.

Namely, the magnetoresistance effect element of the present invention comprises: a free layer; a pinned magnetic layer; and a barrier layer being provided between the free layer and the pinned magnetic layer, and the barrier layer is composed of a semiconductor.

Since the barrier layer is composed of the semiconductor, a barrier height of the barrier layer can be reduced. Therefore, resistance value of the magnetoresistance effect element in the perpendicular-plane direction (RA value) can be reduced with a constant barrier width and without thinning the barrier layer. By reducing the RA value, the problems of the conventional magnetoresistance effect element, e.g., pin holes, break down voltage reduction, can be prevented.

In the magnetoresistance effect element, the barrier layer may be composed of a semiconductor including a base material of MgO and a small amount of donors.

With this structure, the base material of the barrier layer is composed of MgO, so high rate of changing magnetic resistance can be maintained. Further, since the barrier layer is composed of the semiconductor, the high quality magnetoresistance effect element, in which RA value can be reduced and performance deterioration of the barrier layer can be prevented, and a magnetoresistive device including the magnetoresistance effect element can be provided.

In the magnetoresistance effect element, the semiconductor may be an n-type semiconductor.

The magnetoresistance effect element may further comprise: a lower shielding layer; a base layer being formed on the lower shielding layer; an antiferromagnetic layer being formed on the base layer; a cap layer being formed on the free layer; and an upper shielding layer being formed on the cap layer, the pinned magnetic layer may be formed on the antiferromagnetic layer, the barrier layer may be formed on the pinned magnetic layer, and the free layer may be formed on the barrier layer.

With this structure, the high quality magnetoresistance effect element, whose RA value can be reduced, can be provided.

Preferably, the pinned magnetic layer may comprise: a first pinned magnetic layer being formed on the antiferromagnetic layer; an antiferromagnetic coupling layer being formed on the first pinned magnetic layer; and a second pinned magnetic layer being formed on the antiferromagnetic coupling layer.

With this structure, a magnetizing direction of the pinned magnetic layer (the second pinned magnetic layer) can be tightly fixed.

Further, the magnetoresistance effect element may further comprise: a lower shielding layer; an antiferromagnetic layer being formed on the pinned magnetic layer; a cap layer being formed on the antiferromagnetic layer; an upper shielding layer being formed on the cap layer, the free layer may be formed on the lower shielding layer, the barrier layer may be formed on the free layer, and the pinned magnetic layer may be formed on the barrier layer.

With this structure, the high quality magnetoresistance effect element, in which RA value can be reduced, can be provided.

In the magnetoresistance effect element, the pinned magnetic layer may comprise: a second pinned magnetic layer being formed on the barrier layer; an antiferromagnetic coupling layer being formed on the second pinned magnetic layer; and a first pinned magnetic layer being formed on the antiferromagnetic coupling layer.

With this structure, a magnetizing direction of the pinned magnetic layer (the second pinned magnetic layer) can be tightly fixed.

Preferably, the donors are made of one substance selected from the group consisting of: Al, Si and P.

By adding a small amount of the selected substance as the donors, the insulator MgO can be changed to the n-type semiconductor.

The magnetoresistive device of the present invention includes the above described magnetoresistance effect element.

In the magnetoresistive device, the magnetoresistance effect element having the barrier layer is employed, so that very a high magnetoresistance effect can be obtained without deteriorating performance of the barrier layer. Therefore, a high quality magnetoresistive device, e.g., magnetic head with high reproduction sensitivity corresponding to high recording density, MRAM having improved storage property, can be provided.

For example, the magnetoresistance effect element of the present invention can be suitably applied to a data storage unit comprising: a head slider including a magnetoresistance element for reading data recorded on a recording medium, wherein the magnetoresistance effect element comprises a free layer, a pinned magnetic layer, and a barrier layer being provided between the free layer and the pinned magnetic layer and composed of a semiconductor; a suspension supporting the head slider; an actuator arm being capable of turning, wherein an end of the suspension is fixed to the actuator arm; and a signal detection circuit for detecting electric signals for reading the data recorded on the recording medium, the signal detection circuit being electrically connected to the magnetoresistance effect element by insulated wires provided on the suspension and the actuator arm.

### BRIEF DESCRIPTION OF THE DRAWINGS

Embodiments of the present invention will now be described by way of examples and with reference to the accompanying drawings, in which:

FIG. 1 is a schematic sectional view of a first embodiment of the magnetoresistance effect element of the present invention;

FIG. 2 is a schematic sectional view of a second embodiment of the magnetoresistance effect element of the present invention;

FIG. 3 is a schematic sectional view of a third embodiment of the magnetoresistance effect element of the present invention;

FIG. 4 is a schematic sectional view of a fourth embodiment of the magnetoresistance effect element of the present invention;

FIG. 5 is a schematic sectional view of a fifth embodiment of the magnetoresistance effect element of the present invention;

FIG. 6 is an explanation view showing functions and effects of the magnetoresistance effect element; and

FIG. 7 is a schematic sectional view of an example of the magnetoresistive device of the present invention.

FIG. 8 is a schematic sectional view of an example of the data storage unit of the present invention.

### DETAILED DESCRIPTION OF THE EMBODIMENTS

Preferred embodiments of the present invention will now be described in detail with reference to the accompanying drawings.

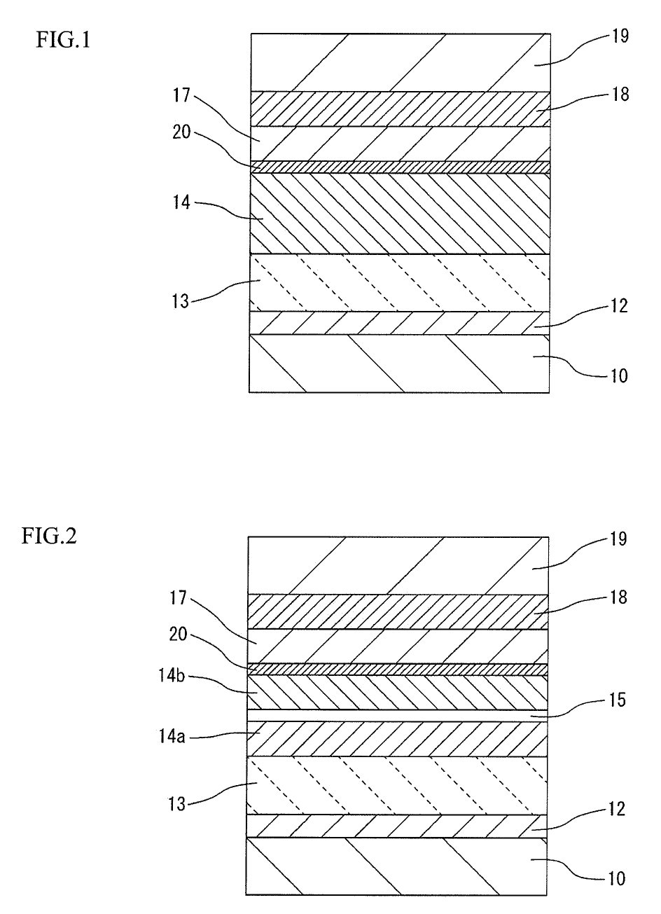

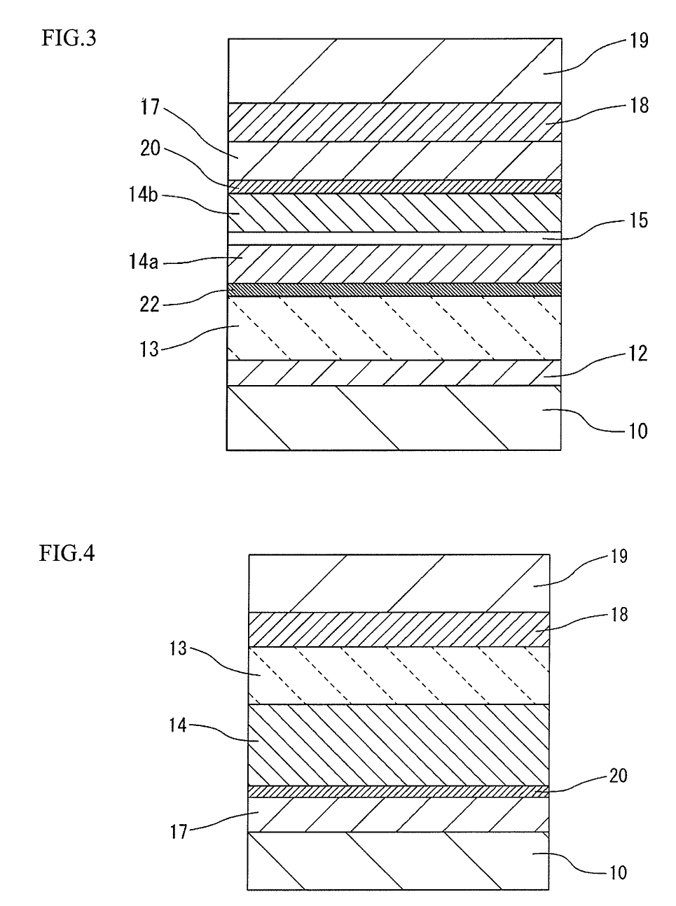

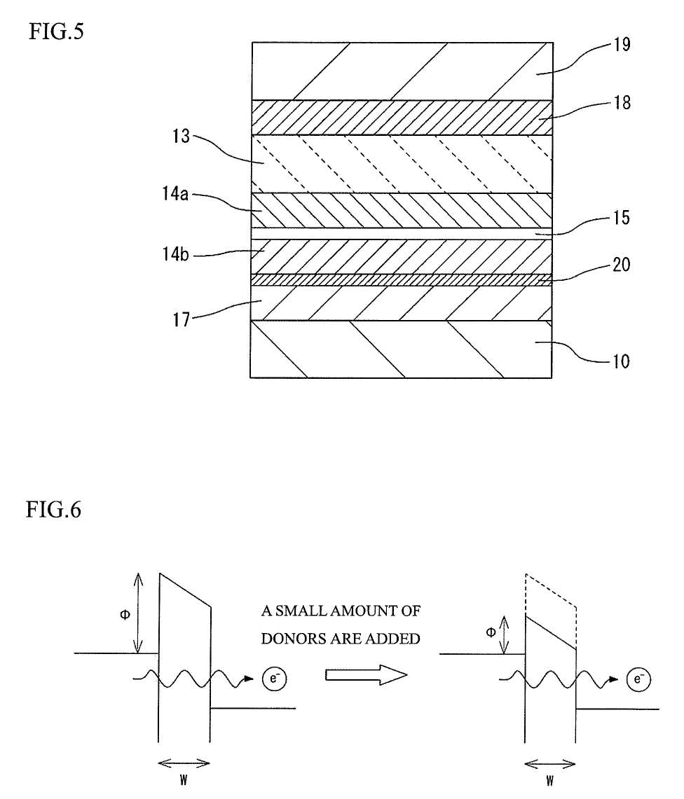

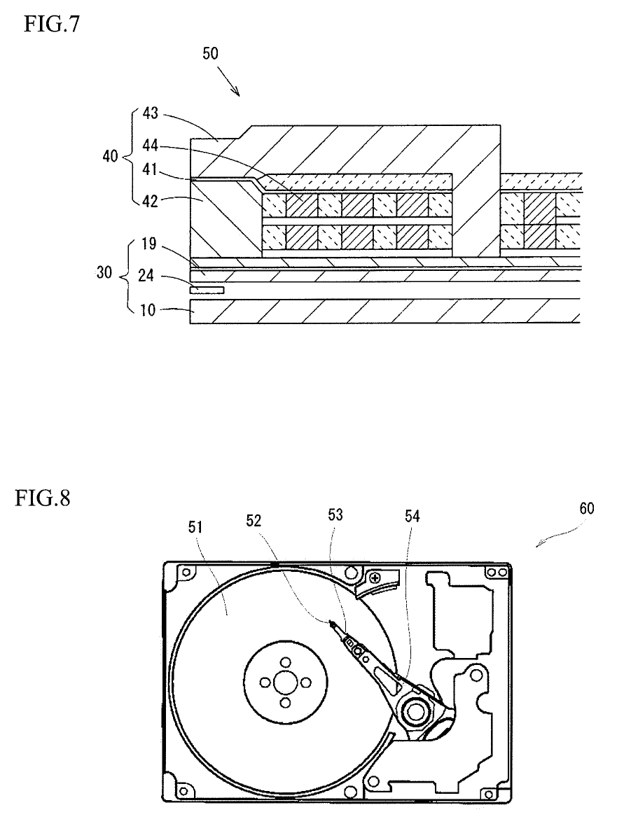

FIG. 1 is a schematic sectional view of a first embodiment of the magnetoresistance effect element of the present invention; FIG. 2 is a schematic sectional view of a second embodiment of the magnetoresistance effect element of the present invention; FIG. 3 is a schematic sectional view of a third embodiment of the magnetoresistance effect element of the present invention; FIG. 4 is a schematic sectional view of a fourth embodiment of the magnetoresistance effect element of the present invention; FIG. 5 is a schematic sectional view of a fifth embodiment of the magnetoresistance effect element of the present invention; FIG. 6 is an explanation view showing functions and effects of the magnetoresistance effect element; FIG. 7 is a schematic sectional view of an example of the magnetoresistive device of the present invention; and FIG. 8 is a schematic sectional view of an example of the data storage unit of the present invention.

Firstly, the first embodiment of the magnetoresistance effect element (TMR element) will be explained.

The TMR element may have various kinds of film structures.

In the first embodiment, as shown in FIG. 1, a lower shielding layer 10, a base layer 12, an antiferromagnetic layer 13, a pinned magnetic layer 14, a barrier layer 20, a free layer 17, a cap layer 18 and an upper shielding layer 19 are laminated in this order.

The lower shielding layer 10 is composed of a soft magnetic material, e.g., NiFe, and formed by plating or sputtering. The lower shielding layer 10 serves as an electrode of the TMR element. Note that, in the following description, the layers are formed by sputtering unless otherwise explained. However, the method of forming the layers is not limited to sputtering.

The base layer 12, which is a two-layered film composed of Ta/Ru, serves as a base of the antiferromagnetic layer 13, which is composed of an antiferromagnetic material including Mn.

The antiferromagnetic layer 13 is composed of IrMn and has a thickness of about 8 nm. Note that, the antiferromagnetic layer 13 fixes a magnetizing direction of the pinned magnetic layer 14 by exchange coupling function.

The pinned magnetic layer 14 is composed of a ferromagnetic material, e.g., CoFe, CoFeB, and has a thickness of about 4 nm.

The free layer 17 is a two-layered film composed of CoFe/NiFe. A magnetizing direction of the free layer 17 is changed by magnetizing signals sent from a recording medium. By detecting resistance variation caused by changing a relative angle between the magnetizing direction of the free layer 17 and that of the pinned magnetic layer 14, recorded data signals can be read.

The cap layer 18, which is a two-layered film composed of Ta/Ru, is formed as a protection layer.

The upper shielding layer 19 is composed of a soft magnetic material, e.g., NiFe, as well as the lower shielding layer 10. The upper shielding layer 19 also serves as an electrode of the TMR element.

The barrier layer 20 is formed between the pinned magnetic layer 14 and the free layer 17. Generally, the barrier layer 20 is composed of alumina or MgO. A sensing current is allowed to pass through the barrier layer 20 by the tunnel effect. A thickness of the barrier layer 20 is about 1 nM.

The magnetoresistance effect element of the present invention is characterized in that the barrier layer 20 is composed of a semiconductor. For example, the semiconductor is an n-type semiconductor including a base material composed of MgO and a small amount of donors. Preferably, the donors are made of one substance selected from the group consisting of: Al, Si and P. By adding a small amount of the selected substance as the donors, the insulator MgO can be changed to the n-type semiconductor.

Resistance of the magnetoresistance effect element in the perpendicular-plane direction (RA value) is defined as following formula:

R∝exp(W\sqrt{Φ}) Formula I
W: barrier width Φ:barrier height

wherein W is a barrier width, and Φ is a barrier height.

In the magnetoresistance effect element of the present invention, according to the formula and FIG. 6, the barrier layer 20, which is composed of MgO and a small amount of the donor, is the n-type semiconductor. Therefore, the barrier height Φ of the MgO layer can be reduced. By reducing the barrier height Φ, the RA value of the magnetoresistance effect element can be reduced without thinning the barrier layer 20. As a result, the problems of the conventional magnetoresistance effect element, i.e., pin holes formed in a thin barrier layer and breakdown voltage reduction caused by pin holes, can be prevented.

As described above, the base material of the barrier layer 20 is composed of MgO, so high rate of changing magnetic resistance can be maintained and effectively corresponded to high density recording. Further, since the barrier layer 20 is composed of the semiconductor, the high quality magnetoresistance effect element, in which the RA value can be reduced and performance deterioration of the barrier layer 20 can be prevented, and a magnetoresistive device including the magnetoresistance effect element can be provided.

Note that, the semiconductor of the barrier layer 20 is the n-type semiconductor, but it may be a p-type semiconductor. In this case too, the same effects can be obtained.

Next, a second embodiment of the magnetoresistance effect element of the present invention will be explained. Note that, the structural elements described in the foregoing embodiment are assigned the same symbols.

In FIG. 2, the pinned magnetic layer 14, which has been explained in the first embodiment, is constituted by a first pinned magnetic layer 14a, a second pinned magnetic layer 14b and an antiferromagnetic coupling layer 15, which couples the pinned magnetic layers 14a and 14b. With this structure, the magnetizing direction of the second pinned magnetic layer 14b can be tightly fixed. Namely, in a magnetoresistance effect element, the resistance variation, which is caused by changing the relative angle between the magnetizing direction of the free layer and that of the pinned magnetic layer, is detected, so that a great effect can be obtained by tightly fixing the magnetizing direction of the pinned magnetic layer.

For example, the first and second pinned magnetic layers 14a and 14b are composed of a ferromagnetic material, e.g., CoFe, CoFeB; the antiferromagnetic coupling layer 15 is composed of Ru. Note that, the magnetizing direction of the second pinned magnetic layer 14a is opposite to that of the first pinned magnetic layer 14b.

Next, a third embodiment of the magnetoresistance effect element of the present invention will be explained. Note that, the structural elements described in the foregoing embodiments are assigned the same symbols.

As shown in FIG. 3, the basic film structure is similar to that of the second embodiment, but an Mn layer 22 is provided between the antiferromagnetic layer 13 composed of the antiferromagnetic material including Mn and the first pinned magnetic layer 14a. With this structure, the function of fixing the magnetizing direction of the pinned magnetic layer can be improved.

Next, a fourth embodiment of the magnetoresistance effect element of the present invention will be explained. Note that, the structural elements described in the foregoing embodiments are assigned the same symbols.

As shown in FIG. 4, the lower shielding layer 10, the free layer 17, the barrier layer 20, the pinned magnetic layer 14, the antiferromagnetic layer 13, the cap layer 18 and the upper shielding layer 19 are laminated in this order. The materials of the layers and the method of forming the layers are the same as those of the first embodiment, so explanation will be omitted.

Next, a fifth embodiment of the magnetoresistance effect element of the present invention will be explained. Note that, the structural elements described in the foregoing embodiments are assigned the same symbols.

As shown in FIG. 5, the pinned magnetic layer 14, which is used in the fourth embodiment, is constituted by the second pinned magnetic layer 14b, the first pinned magnetic layer 14a and the antiferromagnetic coupling layer 15, which is provided between the pinned magnetic layers 14b and 14a. With this structure, the magnetizing direction of the second pinned magnetic layer 14b can be tightly fixed. For example, the first and second pinned magnetic layers 14a and 14b are composed of a ferromagnetic material, e.g., CoFe, CoFeB; the antiferromagnetic coupling layer 15 is composed of Ru. Note that, the magnetizing direction of the second pinned magnetic layer 14a is opposite to that of the first pinned magnetic layer 14b.

Successively, a magnetic head, which is an example of a magnetoresistive device including the above described magnetoresistance effect element, will be explained. Note that, the structural elements described in the foregoing embodiments are assigned the same symbols.

A high quality magnetic head can be produced by assembling the above described magnetoresistance effect element into a read-head of a magnetic head. FIG. 7 shows an embodiment of the magnetic head 50 including the above described magnetoresistance effect element.

The magnetic head 50 is constituted by a read-head 30 and a write-head 40. The read-head 30 includes a magnetoresistance effect element (a read-element) 24, in which a magnetoresistance effect film is provided between the lower shielding layer 10 and the upper shielding layer 19, and the magnetoresistance effect film comprises the antiferromagnetic layer 13, the first pinned magnetic layer 14a, the second pinned magnetic layer 14b, the free layer 17, etc. The write-head 40 includes a lower magnetic pole 42, an upper magnetic pole 43, a write-gap 41 formed between the magnetic poles 42 and 43, and a coil 44 for writing data.

The magnetic head 50 is used in a data storage unit 60. Namely, in the data storage unit 60, the magnetic head 50 is attached to a head slider 52, which writes data on and reads data from a recording medium, e.g., magnetic disk 51. Further, the head slider 52 is mounted on a suspension 53, and an end of the suspension 53 is fixed to a turnable actuator arm 54. The magnetoresistance effect element of the magnetic head 50 is electrically connected to a detection circuit for detecting electric signals for reading the data recorded on the recording medium 51 (see FIG. 8).

In the data storage unit, the head slider is floated from a surface of a magnetic disk by rotating the magnetic disk, and then data can be written on or read from the magnetic disk.

By employing the magnetoresistance effect element whose barrier layer is composed of MgO (and the donors), a very high magnetoresistance effect can be gained, so that reproduction sensitivity can be improved. Namely, the magnetic head, which is capable of corresponding to high recording density, can be produced.

The magnetoresistance effect element of the present invention may be applied to a memory element using a TMR element (MRAM). In the MRAM, a barrier layer is provided between a pinned magnetic layer and a free layer, so that change of a magnetizing direction of the free layer, which is caused by applying an external magnetic field, can be stored, thereby the MRAM can be used as a memory element. In this case too, memory characteristics of the memory element can be improved.

By employing the present invention, the magnetoresistance effect element, in which high reproduction sensitivity corresponding to high recording density is realized by reducing the RA value of the element, can be produced. The RA value can be reduced without thinning the barrier layer composed of MgO (and the donors), so that performance deterioration of the barrier layer, which is caused by pin holes, etc., and reduction of breakdown voltage, which breaks the element, can be prevented. Further, the quality of the magnetoresistance effect element can be improved, so that the quality of the magnetoresistive device using the improved element also can be improved. The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A magnetoresistance effect element,
comprising:
a free layer;
a pinned magnetic layer; and
a barrier layer being provided between the free layer and the pinned magnetic layer,
wherein the barrier layer is composed of a semiconductor.

2. The magnetoresistance effect element according to claim 1, wherein the semiconductor includes a base material of MgO and a small amount of donors.

3. The magnetoresistance effect element according to claim 1, wherein the semiconductor is an n-type semiconductor.

4. The magnetoresistance effect element according to claim 2, wherein the semiconductor is an n-type semiconductor.

5. The magnetoresistance effect element according to claim 1, further comprising:
a lower shielding layer;
a base layer being formed on the lower shielding layer;
an antiferromagnetic layer being formed on the base layer;
a cap layer being formed on the free layer; and
an upper shielding layer being formed on the cap layer,
wherein the pinned magnetic layer is formed on the antiferromagnetic layer,
the barrier layer is formed on the pinned magnetic layer, and
the free layer is formed on the barrier layer.

6. The magnetoresistance effect element according to claim 2, further comprising:
a lower shielding layer;
a base layer being formed on the lower shielding layer;
an antiferromagnetic layer being formed on the base layer;
a cap layer being formed on the free layer; and
an upper shielding layer being formed on the cap layer,
wherein the pinned magnetic layer is formed on the antiferromagnetic layer,
the barrier layer is formed on the pinned magnetic layer, and
the free layer is formed on the barrier layer.

7. The magnetoresistance effect element according to claim 3, further comprising:
a lower shielding layer;
a base layer being formed on the lower shielding layer;
an antiferromagnetic layer being formed on the base layer;
a cap layer being formed on the free layer; and
an upper shielding layer being formed on the cap layer,
wherein the pinned magnetic layer is formed on the antiferromagnetic layer,
the barrier layer is formed on the pinned magnetic layer, and
the free layer is formed on the barrier layer.

8. The magnetoresistance effect element according to claim 4, further comprising:
a lower shielding layer;
a base layer being formed on the lower shielding layer;
an antiferromagnetic layer being formed on the base layer;
a cap layer being formed on the free layer; and
an upper shielding layer being formed on the cap layer,
wherein the pinned magnetic layer is formed on the antiferromagnetic layer,
the barrier layer is formed on the pinned magnetic layer, and
the free layer is formed on the barrier layer.

9. The magnetoresistance effect element according to claim 5, wherein the pinned magnetic layer comprises:
a first pinned magnetic layer being formed on the antiferromagnetic layer;
an antiferromagnetic coupling layer being formed on the first pinned magnetic layer; and
a second pinned magnetic layer being formed on the antiferromagnetic coupling layer.

10. The magnetoresistance effect element according to claim 6, wherein the pinned magnetic layer comprises:
a first pinned magnetic layer being formed on the antiferromagnetic layer;
an antiferromagnetic coupling layer being formed on the first pinned magnetic layer; and
a second pinned magnetic layer being formed on the antiferromagnetic coupling layer.

11. The magnetoresistance effect element according to claim 1, further comprising:
a lower shielding layer;
an antiferromagnetic layer being formed on the pinned magnetic layer;
a cap layer being formed on the antiferromagnetic layer;
an upper shielding layer being formed on the cap layer,
wherein the free layer is formed on the lower shielding layer,
the barrier layer is formed on the free layer, and
the pinned magnetic layer is formed on the barrier layer.

12. The magnetoresistance effect element according to claim 2, further comprising:
a lower shielding layer;
an antiferromagnetic layer being formed on the pinned magnetic layer;
a cap layer being formed on the antiferromagnetic layer;
an upper shielding layer being formed on the cap layer,
wherein the free layer is formed on the lower shielding layer,
the barrier layer is formed on the free layer, and
the pinned magnetic layer is formed on the barrier layer.

13. The magnetoresistance effect element according to claim 3, further comprising:
a lower shielding layer;
an antiferromagnetic layer being formed on the pinned magnetic layer;
a cap layer being formed on the antiferromagnetic layer;
an upper shielding layer being formed on the cap layer,
wherein the free layer is formed on the lower shielding layer,
the barrier layer is formed on the free layer, and
the pinned magnetic layer is formed on the barrier layer.

14. The magnetoresistance effect element according to claim 4, further comprising:
a lower shielding layer;
an antiferromagnetic layer being formed on the pinned magnetic layer;
a cap layer being formed on the antiferromagnetic layer;
an upper shielding layer being formed on the cap layer,
wherein the free layer is formed on the lower shielding layer,
the barrier layer is formed on the free layer, and
the pinned magnetic layer is formed on the barrier layer.

15. The magnetoresistance effect element according to claim 11, wherein
the pinned magnetic layer comprises:
a second pinned magnetic layer being formed on the barrier layer;
an antiferromagnetic coupling layer being formed on the second pinned magnetic layer; and
a first pinned magnetic layer being formed on the antiferromagnetic coupling layer.

16. The magnetoresistance effect element according to claim 12, wherein
the pinned magnetic layer comprises:
a second pinned magnetic layer being formed on the barrier layer;
an antiferromagnetic coupling layer being formed on the second pinned magnetic layer; and
a first pinned magnetic layer being formed on the antiferromagnetic coupling layer.

17. The magnetoresistance effect element according to claim 2, wherein the donors are made of one substance selected from the group consisting of: Al, Si and P.

18. A magnetoresistive device including a magnetoresistance effect element,
wherein the magnetoresistance effect element comprises:
a free layer;
a pinned magnetic layer; and
a barrier layer being provided between the free layer and the pinned magnetic layer and composed of a semiconductor.

19. A data storage unit,
comprising:
a head slider including a magnetoresistance element for reading data recorded on a recording medium, wherein the magnetoresistance effect element comprises a free layer,
a pinned magnetic layer, and a barrier layer being provided between the free layer and the pinned magnetic layer and composed of a semiconductor;
a suspension supporting the head slider;
an actuator arm being capable of turning, wherein an end of the suspension is fixed to the actuator arm; and
a signal detection circuit for detecting electric signals for reading the data recorded on the recording medium, the signal detection circuit being electrically connected to the magnetoresistance effect element by insulated wires provided on the suspension and the actuator arm.
